(19) United States
(12) Patent Application Publication
(10) Pub. No.: US 2021/0007381 A1
(43) Pub. Date: Jan. 14, 2021

(54) CONCENTRATES COMPRISING STEVIA BLENDS AND USES

(71) Applicant: The Coca-Cola Company, Atlanta, GA (US)

(72) Inventors: Youlung Chen, Marietta, GA (US); Juvenal Higiro, Atlanta, GA (US); Indra Prakash, Alpharetta, GA (US); Gil Ma, Atlanta, GA (US); Youngsuk Heo, Cumming, GA (US); Yu Shi, Marietta, GA (US)

(21) Appl. No.: 16/980,627

(22) PCT Filed: Mar. 14, 2019
(86) PCT No.: PCT/US2019/022259

§ 371 Date: Sep. 14, 2020

Related U.S. Application Data
(60) Provisional application No. 62/643,037, filed on Mar. 14, 2018.
(60) Provisional application No. 62/679,193, filed on Jun. 1, 2018.

(51) Int. Cl. A23L 27/30; A23L 2/60; A23L 2/54; A23L 2/62

(52) U.S. Cl. CPC A23L 27/36; A23L 2/60; A23V 2002/00; A23L 2/62; A23L 2/54

(57) ABSTRACT

Steviol glycoside blends having aqueous solubilities suitable for beverage symp concentrations are provided herein. Methods of preparing concentrates from said blends are also provided, as are beverage syrups and beverages. Methods of improving the solubility and reducing foaming of Stevia blends are also provided.

### CROSS REFERENCE TO RELATED APPLICATIONS

The present application claims priority to U.S. Provisional Application No. 62/643,037, filed Mar. 14, 2018 and U.S. Provisional Application No. 62/679,193, filed Jun. 1, 2018. The contents of the above-referenced applications are incorporated by reference in their entirety.

### FIELD OF THE INVENTION

The present invention relates generally to concentrated solutions of steviol glycosides and optionally, mogrosides, suitable for preparing beverage syrups and, ultimately, beverages. Methods of preparing beverage syrups and beverages from the concentrated solutions are also provided herein.

### BACKGROUND OF THE INVENTION

Stevia is the common name for Stevia rebaudiana (Bertoni), a perennial shrub of the Asteracae (Compositae) family native to Brazil and Paraguay. Stevia leaves, the aqueous extract of the leaves, and purified steviol glycosides isolated from Stevia have been developed as sweeteners desirable as both non-caloric and natural in origin. Steviol glycosides isolated from Stevia rebaudiana include stevioside, rebaudioside A, rebaudioside C, dulcoside A, rubusoside, steviolbioside, rebaudioside B, rebaudioside D and rebaudioside F.

Reb M (also called rebaudioside X), (13-[(2-O-β-D-glucopyranosyl-3-O-β-D-glucopyranosyl-β-D-glucopyranosyl)oxy] ent kaur-16-en-19-oic acid-[(2-O-β-D-glucopyranosyl-3-O-β-D-glucopyranosyl-β-D-glucopyranosyl) ester], was isolated from Stevia rebaudiana and characterized:

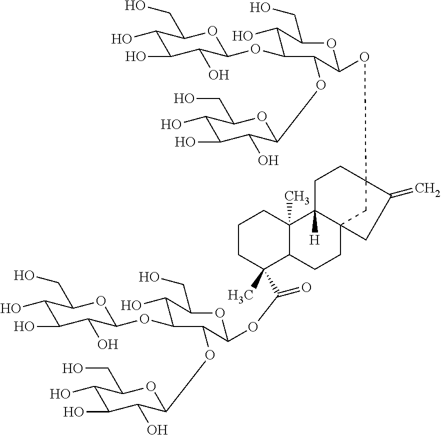

Many steviol glycosides are present in minute quantities in Stevia rebaudiana, including Reb M which represents only about 0.05%-0.5% by weight of the leaf. Recently, it was found that Reb M could be used as a sweetener for beverages.

A concentration of at least 0.25% (% w/w) is useful for beverage syrups. Syrups having such concentrations can readily be diluted to beverages. However, crystalline rebaudioside M compositions have poor aqueous solubility and dissolution qualities in beverage formulations. For example, certain crystalline compositions containing about 75-90% rebaudioside M and about 25-10% rebaudioside D by weight cannot be dissolved above concentrations of 0.1-0.15% (% w/w) at room temperature.

Increasing the temperature of the steviol glycoside solution can increase the solubility, as can the addition of co-solvents such as ethanol. However, these are not desirable approaches compatible with the syrup manufacture process.

A reb M dosing skid has been developed to address the solubility issues when formulating syrups into full strength beverages at the bottler stage, but such equipment is expensive and must be installed at every bottler.

As such, there remains a need for methods to provide concentrated solutions of steviol glycoside sweeteners typical of beverage syrups.

### SUMMARY OF THE INVENTION

The present invention generally relates to use of reb N, mogroside V and siamenoside I in certain amounts to improve the solubility of certain Stevia blends having poor solubility that are unable to be formulated at relevant beverage syrup concentrations (˜0.25-0.4 wt %). In particular, use of reb N, mogroside V and siamenoside I improves the solubility of Stevia blends containing reb M, optionally in combination with any of reb A, reb B, reb D, reb E, reb O and combinations thereof. Use of reb N, mogroside V and siamenoside I as described herein not only improves solubility, but also provides blends with similar taste profiles compared to reb M and/or RebM80. Moreover, in some embodiments, use of reb N, mogroside V and siamenoside I as described herein reduces foaming.

The present invention also generally relates to blends that exhibit superior aqueous solubility at relevant beverage syrup concentrations (˜0.25-0.4 wt %) compared to crystalline reb M or RebM80 alone. The increased aqueous solubility allows for production of beverages prepared from these concentrates and eliminates the need for a skid, heating steps and/or additional solubilizing reagents during manufacturing. The resulting beverages have a similar taste profile to beverages sweetened with reb M or RebM80. In some embodiments, the beverage syrups prepared from the concentrates exhibit less foaming compared to beverage syrups when formulated into beverages.

The blends of the present invention are capable of being formulated into concentrates having steviol glycoside concentrations required to formulate beverage syrups to prepare diet beverages, e.g. about 0.25 wt % to about 0.4 wt % (up to about 600 ppm). The concentrates are clear by visual inspection. As such, the present invention provides a concentrate having from about 0.25 wt % to about 0.4 wt % steviol glycoside content comprising water and a blend of the present invention.

The present invention also provides super concentrates comprising from about 1 wt % to about 10 wt % steviol glycoside content, prepared by (i) combining a blend of the present invention and water at room temperature to provide a mixture, wherein both the blend and water are present in amounts necessary to provide the desired steviol glycoside concentration/wt % (e.g. about 2%), and (ii) stirring the mixture at room temperature for at least 10 minutes. The resulting super concentrate is cloudy, i.e. not a solution.

The super concentrate can be diluted to a concentration typical of beverage syrups, e.g. about 0.25-0.4 wt %, providing a clear concentrate by visual inspection. This process is done without heating, addition of solubilizing agents or expensive skids. Accordingly, a concentrate is prepared by (i) diluting the super concentrate to the desired steviol glycoside concentration/wt % (e.g. about 0.25 wt %) with water and (ii) mixing for at least about 10 minutes

Beverage syrups can be prepared from the concentrate by addition of beverage syrup ingredients. Alternative, the concentrate is a beverage syrup.

Beverage syrups of the present invention can be formulated into beverages using typical equipment found in a bottling facility. A method of preparing a beverage comprising mixing a beverage syrup of the present invention with an amount of diluting water. The volumetric ratio of syrup to water is typically from about 1:3 to about 1:8.

In a particular embodiment, beverages of the present invention are reduced or zero-calorie carbonated beverages, wherein the blend is the only sweetener.

### BRIEF DESCRIPTION OF THE FIGURES

FIG. 1 shows foam heights of RebA+MogV blends in final beverages at total concentrations of 100, 300 and 500 ppm. X and Y axes denote percentage of Mog V in each blend and foam height (mL) respectively.

FIG. 2 shows foam heights of RebM+MogV blends in final beverages at total concentrations of 100, 300 and 500 ppm. X and Y axes denote percentage of Mog V in each blend and foam height (mL) respectively.

FIG. 3 shows foam diminishing times of RebA+MogV blends in final beverages at total concentrations of 100, 300 and 500 ppm. X and Y axes denote percentage of Mog V in each blend and foam diminishing time(s) respectively.

FIG. 4 shows foam diminishing times of RebM+MogV blends in final beverages at total concentrations of 100, 300 and 500 ppm. X and Y axes denote percentage of Mog V in each blend and foam diminishing time(s) respectively.

FIG. 5 shows foam heights of RebA+Siamenoside I blends in final beverages at total concentrations of 100, 300 and 500 ppm. X and Y axes denote percentage of Siamenoside I in each blend and foam height (mL) respectively.

FIG. 6 shows foam heights of RebM+Siamenoside I blends in final beverages at total concentrations of 100, 300 and 500 ppm. X and Y axes denote percentage of Siamenoside I in each blend and foam height (mL) respectively.

FIG. 7 shows foam diminishing times of RebA+Siamenoside I blends in final beverages at total concentrations of 100, 300 and 500 ppm. X and Y axes denote percentage of Siamenoside I in each blend and foam diminishing time(s) respectively.

FIG. 8 shows foam diminishing times of RebM+Siamenoside I blends in final beverages at total concentrations of 100, 300 and 500 ppm. X and Y axes denote percentage of Siamenoside I in each blend and foam diminishing time(s) respectively.

### DETAILED DESCRIPTION OF THE INVENTION

I. Definitions

“Beverage”, as used herein, refers to liquids suitable for human consumption.

“Solution”, as used herein, refers to a liquid mixture in which the minor component (the solute) is uniformly distributed within the major component (the solvent). A solution is clear and does not contain particulate matter, in contrast to a suspension or cloudy mixture.

“Syrup” or “Beverage syrup”, as used herein, refers to a beverage precursor to which a fluid, typically water, is added to form a ready-to-drink beverage, or a “beverage.” Typically, the volumetric ratio of syrup to water is between 1:3 to 1:8, more typically between 1:4 and 1:6. The volumetric ratio of syrup to water also is expressed as a “throw.” A 1:5 ratio, which is a ratio commonly used within the beverage industry, is known as a “1+5 throw.”

“Steviol glycoside mixture comprising reb M”, as used herein, refers to a mixture containing at least about 80% reb M by weight, such as, for example, at least about 85% by weight, at least about 90% by weight, at least about 95% by weight, at least about 97% by weight or any range in between.

The steviol glycoside mixture comprising reb M can be RebM80. “RebM80” refers to a steviol glycoside mixture containing at least 80% Reb M by weight (the majority of the remainder is Reb D and Reb A). The total steviol glycoside content of the mixture is at least 95%. The steviol glycoside mixture comprising reb M can also be 95% reb M, i.e. a steviol glycoside mixture comprising reb M in about 95% by weight.

“Steviol glycoside mixture comprising reb A”, as used herein, refers to a mixture containing at least about 80% reb A by weight, such as, for example, at least about 85% by weight, at least about 90% by weight, at least about 95% by weight, at least about 97% by weight or any range in between. In one example, the steviol glycoside mixture comprising reb A can also be 95% reb A, i.e. a steviol glycoside mixture comprising reb A in about 95% by weight.

II. Blends

A. Reb N-Containing Blends

In some embodiments, the blends of the present invention contain reb M and reb N. In one aspect, a steviol glycoside blend comprises (i) from about 20 wt % to less than about 70 wt % of a steviol glycoside mixture comprising reb M and (ii) from about 20 wt % to about 80 wt % reb N.

The blends can further comprise other steviol glycosides including, but not limited to, reb A, reb B, reb C, reb G, reb N, reb D, reb E, reb O, reb J, isorebM, reb I and combinations thereof. Unless specified otherwise, the purity of the reb is at least about 90% by weight, such as, for example, at least about 95% by weight.

Blends of the present invention exhibit superior aqueous solubility from about 0.25 wt % to about0.4 wt % compared to a blend of only the steviol glycoside mixture comprising reb M, e.g. 95% reb M or RebM80. In one embodiment, the aqueous solubility of the blend of the present at 0.25 wt %-0.4 wt % is at least about 1.5× more than the aqueous solubility of the blend of only the steviol glycoside mixture comprising reb M, such as, for example, at least about 1.7× more or least about 2.0× more.

Blends of the present invention exhibit superior aqueous solubility at 0.25 wt %-0.4 wt % compared to the blend without reb N. In one embodiment, the solubility of the blend of the present invention has an aqueous solubility at 0.25 wt %-0.4 wt % that is at least about 1.5× more than the aqueous solubility of the blend without reb N, such as, for example, at least about 1.7× more or least about 2.0× more.

Blends of the present invention also exhibit similar (non-statistically different) taste profiles to a blend of only the steviol glycoside mixture comprising reb M. When the blends are formulated into beverages, beverages prepared from blends of the present invention have a similar taste profile to a corresponding beverage sweetened with the steviol glycoside mixture comprising reb M, e.g. 95% reb M or RebM80. For example, beverages of the instant invention have one or more of the same attributes as the corresponding beverage sweetened with the steviol glycoside mixture comprising reb M: sweetness, sweetness linger, bitterness, licorice flavor, mouthfeel, temporal profile, sweetness onset, etc. Methods of determining these attributes are well-known to those of skill in the art.

In preferred embodiments, blends of the present invention exhibit (i) superior aqueous solubility at syrup concentrations (e.g. from about 0.25 wt % to about 0.4 wt %) compared to a blend of only the steviol glycoside mixture comprising reb M, e.g. 95% reb M or RebM80, and (ii) have similar taste profiles compared to the blend of only the steviol glycoside mixture comprising reb M when formulated into a beverage.

In some embodiments, blends of the present invention also exhibit reduced foaming during bottling compared to (i) a blend of only the steviol glycoside mixture comprising reb M, e.g. 95% reb M or RebM80 and/or (ii) reb A and/or (iii) the blend without reb N. That is, when the blends are formulated into concentrates or beverage syrups at 0.25 wt %-0.4 wt % and subsequently diluted to beverages, beverages prepared from concentrates or beverage syrups containing blends of the present invention exhibit reduced foaming compared to a corresponding beverage sweetened with (i) a blend of only the steviol glycoside mixture comprising reb M, e.g. 95% reb M or RebM80 and/or (ii) reb A and/or the blend without reb N.

Foaming can be measured by both foam height (level of uniform foam throughout the circumference of the beaker when sample poured into beaker) and foam diminish time (time from when a sample hits the bottom of the container and the time when the foam diminishes to provide desired beverage volume level). Methods of determining both foam height and foam diminish time are known to those of skill in the art.

Beverages prepared from concentrates or beverage syrups containing blends of the present invention exhibit foam diminish time that is at least about 5% less, at least about 10% less, at least about 20% less or at least about 40% less compared to a corresponding beverage sweetened with (i) a blend of only the steviol glycoside mixture comprising reb M, e.g. 95% reb M or RebM80 or (ii) reb A.

It should be noted that the reduced foaming does not apply to blends containing reb B in significant (i.e. not trace) amounts.

The blends of the present invention can be formulated into aqueous solutions (concentrates) having a steviol glycoside content suitable for beverage syrups, e.g. about 0.25 wt % to about 0.4 wt %, such as, for example, about 0.25 wt %, about 0.30 wt %, about 0.35 wt % or about 0.4 wt %

A blend of the present invention comprises less than about 70% reb M, less than about 35% reb A, less than 25% reb B, less than about 70% reb N, less than about 20% reb D, less than about 30% Reb E, less than about 20% reb O, and less than about 35% reb J.

A blend of the present invention comprises from about 0.1% to about 70% reb M, from about 0.1% to about 35% reb A, from about 0.1% to about 25% reb B, from about 0.1% to about 70% reb N, from about 0.1% to about 20% reb D, from about 0.1% to about 30% Reb E, from about 0.1% to about 20% reb O, and from about 0.1% to about 35% reb J.

One diblend of the present invention comprises (i) a steviol glycoside mixture comprising reb M and (ii) reb N. In a more particular embodiment, the diblend consists essentially of (i) a steviol glycoside mixture comprising reb M and (ii) reb N. In a still further particular embodiment, the diblend consists of (i) a steviol glycoside mixture comprising reb M and (ii) reb N.

The relative amounts of the steviol glycoside mixture comprising reb M and reb N influence aqueous solubility at relevant beverage syrup concentrations, i.e. about 0.25 wt % to about 0.4 wt %. To achieve this concentration without precipitation or other solubility issues, the diblend comprises from about 20 wt % to about 60 wt % of the steviol glycoside mixture comprising reb M and from about 80 wt % to about 40 wt % reb N, such as, for example, from about 20 wt % to about 50 wt % of the steviol glycoside mixture comprising reb M and about 80 wt % to about 50 wt % reb N; from about 20 wt % to about 40 wt % of the steviol glycoside mixture comprising reb M and from about 80 wt % to about 60 wt % reb N; from about 20 wt % to about 30 wt % of the steviol glycoside mixture comprising reb M and from about 80% to about 70 wt % reb N; from about 30 wt % to about 60 wt % of the steviol glycoside mixture comprising reb M and about 70 wt % to about 40 wt % reb N; from about 30 wt % to about 50 wt % of the steviol glycoside mixture comprising reb M and from about 70 wt % to about 50 wt % reb N; from about 30 wt % to about 40 wt % of the steviol glycoside mixture comprising reb M and about 70 wt % to about 60 wt % reb N; from about 40 wt % to about 60 wt % of the steviol glycoside mixture comprising reb M and from about 60 wt % to about 40 wt % reb N; from about 40 wt % to about 50 wt % of the steviol glycoside mixture comprising reb M and from about 60 wt % to about 50 wt % reb N; and about 50 wt % of the steviol glycoside mixture comprising reb M and about 50 wt % reb N.

One triblend of the present invention comprises (i) a steviol glycoside mixture comprising reb M, (ii) reb A and (iii) reb N. In a more particular embodiment, the triblend consists essentially of (i) a steviol glycoside mixture comprising reb M, (ii) reb A and (iii) reb N. In a still further particular embodiment, a triblend consists of (i) a steviol glycoside mixture comprising reb M, (ii) reb A and (iii) reb N.

The relative amounts of the steviol glycoside mixture comprising reb M, reb A and reb N influence aqueous solubility at relevant beverage syrup concentrations, i.e. about 0.25 wt % to about 0.4 wt %. To achieve this concentration without precipitation or other solubility issues, the triblend comprises from about 40 wt % to about 50 wt % of the steviol glycoside mixture comprising reb M, from about 10 wt % to about 20 wt % reb A and from about 40 wt % to about 50 wt % reb N. In a more particular embodiment, the triblend comprises from about 40 wt % to about 50 wt % RebM80, from about 10 wt % to about 20 wt % reb A and from about 40 wt % to about 50 wt % reb N.

Another triblend of the present invention comprises (i) a steviol glycoside mixture comprising reb M, (ii) reb N and (iii) reb D. In a more particular embodiment, the triblend consists essentially of (i) a steviol glycoside mixture comprising reb M, (ii) reb N and (iii) reb D. In a still further particular embodiment, the triblend consists of (i) a steviol glycoside mixture comprising reb M, (ii) reb N and (iii) reb D.

The relative amounts of the steviol glycoside mixture comprising reb M, reb N and reb D influence aqueous solubility at relevant beverage syrup concentrations, i.e. about 0.25 wt % to about 0.4 wt %. To achieve this concentration without precipitation or other solubility issues, the triblend comprises from about 40 wt % to about 50 wt % of the steviol glycoside mixture comprising reb M, from about 45 wt % to about 55 wt % reb N and from about 1 wt % to about 10 wt % reb D. In a more particular embodiment, the triblend comprises from about 40 wt % to about 50 wt % RebM80, from about 45 wt % to about 55 wt % reb N and from about 1 wt % to about 10 wt % reb D.

Still another triblend of the present invention comprises (i) a steviol glycoside mixture comprising reb M, (ii) reb A and (iii) reb B. In a more particular embodiment, the triblend consists essentially of (i) a steviol glycoside mixture comprising reb M, (ii) reb A and (iii) reb B. In a still further particular embodiment, the triblend consists of (i) a steviol glycoside mixture comprising reb M, (ii) reb A and (iii) reb B. In one embodiment, the steviol glycoside mixture comprising reb M contains at least about 95% reb M by weight.

The relative amounts of the steviol glycoside mixture comprising reb M, reb A and reb B influence aqueous solubility at relevant beverage syrup concentrations, i.e. about 0.25 wt % to about 0.4 wt %. To achieve this concentration without precipitation or other solubility issues, the triblend comprises from about 45 wt % to about 55 wt % of the steviol glycoside mixture comprising reb M, from about 30 wt % to about 40 wt % reb A and from about 5 wt % to about 20 wt % reb B.

Yet another triblend of the present invention comprises (i) reb A, (ii) reb N and (iii) reb B. In a more particular embodiment, the triblend consists essentially of (i) reb A, (ii) reb N and (iii) reb B. In a still further particular embodiment, the triblend comprises (i) a steviol glycoside mixture comprising reb A, (ii) reb N and (iii) reb B.

The relative amounts of reb A, reb N and reb B influence aqueous solubility at relevant beverage syrup concentrations, i.e. about 0.25 wt % to about 0.4 wt %. To achieve this concentration without precipitation or other solubility issues, the triblend comprises from about 30 wt % to about 40 wt % reb A, from about 45 wt % to about 55 wt % reb N and from about 5 wt % to about 20 wt % reb B.

A further triblend of the present invention comprises (i) a steviol glycoside mixture comprising reb M, (ii) reb N and (iii) reb B. In a more particular embodiment, the triblend consists essentially of (i) a steviol glycoside mixture comprising reb M, (ii) reb N and (iii) reb B. In a more particular embodiment, the triblend consists of (i) a steviol glycoside mixture comprising reb M, (ii) reb N and (iii) reb B.

The relative amounts of (i) a steviol glycoside mixture comprising reb M, (ii) reb N and (iii) reb B influence aqueous solubility at relevant beverage syrup concentrations, i.e. about 0.25 wt % to about 0.4 wt %. To achieve this concentration without precipitation or other solubility issues, the triblend comprises from about 35 wt % to about 45 wt % of the steviol glycoside mixture comprising reb M, from about 35 wt % to about 45 wt % reb N and from about 5 wt % to about 25 wt % reb B.

One quaternary blend of the present invention comprises (i) a steviol glycoside mixture comprising reb M, (ii) reb N, (iii) reb D and (iv) reb O. In a more particular embodiment, the quaternary blend consists essentially of (i) a steviol glycoside mixture comprising reb M, (ii) reb N, (iii) reb D and (iv) reb O. In a still further particular embodiment, the quaternary blend consists of (i) a steviol glycoside mixture comprising reb M, (ii) reb N, (iii) reb D and (iv) reb O.

The relative amounts of the steviol glycoside mixture comprising reb M, reb N, reb D and reb O influence aqueous solubility at relevant beverage syrup concentrations, i.e. about 0.25 wt % to about 0.4 wt %. To achieve this concentration without precipitation or other solubility issues, the quaternary blend comprises from about 30 wt % to about 50 wt % of the steviol glycoside mixture comprising reb M, from about 30 wt % to about 40 wt % reb N, from about 5 wt % to about 15 wt % reb D and from about 10 wt % to about 20 wt % reb O. In a more particular embodiment, the quaternary blend comprises from about from about 30 wt % to about 50 wt % RebM80, from about 30 wt % to about 40 wt % reb N, from about 5 wt % to about 15 wt % reb D and from about 15 wt % to about 20 wt % reb O.

Another quaternary blend of the present invention comprises (i) a steviol glycoside mixture comprising reb M, (ii) reb N, (iii) reb D and (iv) reb E. In a more particular embodiment, the quaternary blend consists essentially of (i) a steviol glycoside mixture comprising reb M, (ii) reb N, (iii) reb D and (iv) reb E. In a still further particular embodiment, the quaternary blend consists of (i) a steviol glycoside mixture comprising reb M, (ii) reb N, (iii) reb D and (iv) reb E.

The relative amounts of the steviol glycoside mixture comprising reb M, reb N, reb D and reb E influence aqueous solubility at relevant beverage syrup concentrations, i.e. about 0.25 wt % to about 0.4 wt %. To achieve this concentration without precipitation or other solubility issues, the quaternary blend comprises from about 35 wt % to about 45 wt % of the steviol glycoside mixture comprising reb M, from about 35 wt % to about 45 wt % reb N, from about 5 wt % to about 15 wt % reb D and from about 5 wt % to about 20 wt % reb E. In a more particular embodiment, the quaternary blend comprises from about 35 wt % to about 45 wt % of the steviol glycoside mixture comprising reb M, from about 35 wt % to about 45 wt % reb N, from about 5 wt % to about 15 wt % reb D and from about 10 wt % to about 20 wt % reb E.

Still another quaternary blend comprises (i) a steviol glycoside blend comprising reb M, (ii) reb A, (iii) reb B and (iv) reb D. In a more particular embodiment, the quaternary blend consists essentially of (i) a steviol glycoside blend comprising reb M, (ii) reb A, (iii) reb B and (iv) reb D. In a still further particular embodiment, the quaternary blend consists of (i) a steviol glycoside blend comprising reb M, (ii) reb A, (iii) reb B and (iv) reb D.

The relative amounts of the steviol glycoside mixture comprising reb M, reb A, reb B and reb D influence aqueous solubility at relevant beverage syrup concentrations, i.e. about 0.25 wt % to about 0.4 wt %. To achieve this concentration without precipitation or other solubility issues, the quaternary blend comprises from about 35 wt % to about 45 wt % of the steviol glycoside mixture comprising reb M, from about 30 wt % to about 40 wt % reb A, from about 5 wt % to about 25 wt % reb B and from about 5 wt % to about 15 wt % reb D.

Yet another quaternary blend comprises (i) a steviol glycoside blend comprising reb M, (ii) reb D, (iii) reb N and (iv) reb B. In a more particular embodiment, the quaternary blend consists essentially of (i) a steviol glycoside blend comprising reb M, (ii) reb D, (iii) reb N and (iv) reb B. In a still more particular embodiment, the quaternary blend consists of (i) a steviol glycoside blend comprising reb M, (ii) reb D, (iii) reb N and (iv) reb B.

The relative amounts of the steviol glycoside mixture comprising reb M, reb D, reb N and reb B influence aqueous solubility at relevant beverage syrup concentrations, i.e. about 0.25 wt % to about 0.4 wt %. To achieve this concentration without precipitation or other solubility issues, the quaternary blend comprises from about 30 wt % to about 40 wt % of the steviol glycoside mixture comprising reb M, from about 1 wt % to about 15 wt % reb D, from about 35 wt % to about 45 wt % reb N and from about 5 wt % to about 25 wt % reb B.

A further quaternary blend comprises (i) a steviol glycoside blend comprising reb M, (ii) reb D, (iii) reb N and (iv) reb O. In a more particular embodiment, the quaternary blend consists essentially of (i) a steviol glycoside blend comprising reb M, (ii) reb D, (iii) reb N and (iv) reb O. In a still more particular embodiment, the quaternary blend consists of (i) a steviol glycoside blend comprising reb M, (ii) reb D, (iii) reb N and (iv) reb O.

The relative amounts of the steviol glycoside mixture comprising reb M, reb D, reb N and reb O influence aqueous solubility at relevant beverage syrup concentrations, i.e. about 0.25 wt % to about 0.4 wt %. To achieve this concentration without precipitation or other solubility issues, the quaternary blend comprises from about 30 wt % to about 40 wt % of the steviol glycoside mixture comprising reb M, from about 1 wt % to about 10 wt % reb D, from about 35 wt % to about 45 wt % reb N and from about 1 wt % to about 20 wt % reb O.

B. Mogroside V-Containing Blends

In some embodiments, a blend of the present invention contains reb M and mogroside V. In one aspect, a blend comprises (i) from about 20 wt % to about 70 wt % of a steviol glycoside mixture comprising reb M and (ii) from about 20 wt % to about 80 wt % mogroside V. In another aspect, a blend comprises (i) from about 20 wt % to about 70 wt % of a steviol glycoside mixture comprising reb A and (ii) from about 20 wt % to about 80 wt % mogroside V.

The blends can further comprise other steviol glycosides including, but not limited to, reb A, reb M, reb B, reb C, reb G, reb N, reb D, reb E, reb O, reb J, isorebM, reb I and combinations thereof. Unless specified otherwise, the purity of the reb and/or mogroside V is at least about 90% by weight, such as, for example, at least about 95% by weight.

The blends of the present invention containing reb M and mogroside V exhibit reduced foaming during bottling compared to (i) a blend of only the steviol glycoside mixture comprising reb M, e.g. 95% reb M or RebM80 and/or (ii) the blend without mogroside V. That is, when the blends are formulated into concentrates or beverage syrups at 0.25 wt %-0.4 wt % and subsequently diluted to beverages, beverages prepared from concentrates or beverage syrups containing blends of the present invention exhibit reduced foaming compared to a corresponding beverage sweetened with (i) a blend of only the steviol glycoside mixture comprising reb M, e.g. 95% reb M or RebM80 and/or (ii) the blend without mogroside V.

The blends of the present invention containing reb M and mogroside V exhibit reduced foaming during bottling compared to (i) a blend of only the steviol glycoside mixture comprising reb A and/or (ii) the blend without mogroside V. That is, when the blends are formulated into concentrates or beverage syrups at 0.25 wt %-0.4 wt % and subsequently diluted to beverages, beverages prepared from concentrates or beverage syrups containing blends of the present invention exhibit reduced foaming compared to a corresponding beverage sweetened with (i) a blend of only the steviol glycoside mixture comprising reb A and/or (ii) the blend without mogroside V.

Methods of measuring foam height and foam diminish time are described above and known in the art. Beverages prepared from concentrates or beverage syrups containing blends comprising reb M and mogroside V exhibit foam diminish time that is at least about 5% less, at least about 10% less, at least about 20% less or at least about 40% less compared to a corresponding beverage sweetened with a blend of only the steviol glycoside mixture comprising reb M, e.g. 95% reb M or RebM80. Beverages prepared from concentrates or beverage syrups containing blends comprising reb A and mogroside V exhibit foam diminish time that is at least about 5% less, at least about 10% less, at least about 20% less or at least about 40% less compared to a corresponding beverage sweetened with a blend of only the steviol glycoside mixture comprising reb A.

One diblend of the present invention comprises (i) a steviol glycoside mixture comprising reb M and (ii) mogroside V. In a more particular embodiment, the diblend consists essentially of (i) a steviol glycoside mixture comprising reb M and (ii) mogroside V. In a still further particular embodiment, the diblend consists of (i) a steviol glycoside mixture comprising reb M and (ii) mogroside V.

The relative amounts of the steviol glycoside mixture comprising reb M and mogroside V influence foaming. Preferably, the diblend comprises from about 20 wt % to about 70 wt % of the steviol glycoside mixture comprising reb M and from about 30 wt % to about 80 wt % mogroside V, such as, for example, from about 20 wt % to about 60 wt % of the steviol glycoside mixture comprising reb M and about 80 wt % to about 30 wt % mogroside V; from about; from about 20 wt % to about 50 wt % of the steviol glycoside mixture comprising reb M and from about 80 wt % to about 50 wt % mogroside V; from about 20 wt % to about 40 wt % of the steviol glycoside mixture comprising reb M and from about 80% to about 60 wt % mogroside V; from about 20 wt % to about 30 wt % of the steviol glycoside mixture comprising reb M and from about 80 wt % to about 70 wt % mogroside V; from about 30 wt % to about 70 wt % of the steviol glycoside mixture comprising reb M and from about 70 wt % to about 30 wt % mogroside V; from about 30 wt % to about 60 wt % of the steviol glycoside mixture comprising reb M and about 70 wt % to about 40 wt % mogroside V; from about 30 wt % to about 50 wt % of the steviol glycoside mixture comprising reb M and from about 70 wt % to about 50 wt % mogroside V; from about 30 wt % to about 40 wt % of the steviol glycoside mixture comprising reb M and about 70 wt % to about 60 wt % mogroside V; from about 40 wt % to about 70 wt % of the steviol glycoside mixture comprising reb M and from about 60 wt % to about 30 wt % mogroside V; from about 40 wt % to about 60 wt % of the steviol glycoside mixture comprising reb M and from about 60 wt % to about 40 wt % mogroside V; from about 40 wt % to about 50 wt % of the steviol glycoside mixture comprising reb M and from about 60 wt % to about 50 wt % mogroside V; and about 50 wt % of the steviol glycoside mixture comprising reb M and about 50 wt % mogroside V.

Another diblend of the present invention comprises (i) a steviol glycoside mixture comprising reb A and (ii) mogroside V. In a more particular embodiment, the diblend consists essentially of (i) a steviol glycoside mixture comprising reb A and (ii) mogroside V. In a still further particular embodiment, the diblend consists of (i) a steviol glycoside mixture comprising reb A and (ii) mogroside V.

The relative amounts of the steviol glycoside mixture comprising reb A and mogroside V influence foaming. Preferably, the diblend comprises from about 20 wt % to about 70 wt % of the steviol glycoside mixture comprising reb A and from about 30 wt % to about 80 wt % mogroside V, such as, for example, from about 20 wt % to about 60 wt % of the steviol glycoside mixture comprising reb A and about 80 wt % to about 40 wt % mogroside V; from about 20 wt % to about 50 wt % of the steviol glycoside mixture comprising reb A and from about 80 wt % to about 50 wt % mogroside V; from about 20 wt % to about 40 wt % of the steviol glycoside mixture comprising reb A and from about 80% to about 60 wt % mogroside V; from about 20 wt % to about 30 wt % of the steviol glycoside mixture comprising reb A and from about 80 wt % to about 70 wt % mogroside V; from about 30 wt % to about 70 wt % of the steviol glycoside mixture comprising reb A and from about 70 wt % to about 30 wt % mogroside V; from about 30 wt % to about 60 wt % of the steviol glycoside mixture comprising reb A and about 70 wt % to about 40 wt % mogroside V; from about 30 wt % to about 50 wt % of the steviol glycoside mixture comprising reb A and from about 70 wt % to about 50 wt % mogroside V; from about 30 wt % to about 40 wt % of the steviol glycoside mixture comprising reb A and about 70 wt % to about 60 wt % mogroside V; from about 40 wt % to about 70 wt % of the steviol glycoside mixture comprising reb A and from about 60 wt % to about 30 wt % mogroside V; from about 40 wt % to about 60 wt % of the steviol glycoside mixture comprising reb A and from about 60 wt % to about 40 wt % mogroside V; from about 40 wt % to about 50 wt % of the steviol glycoside mixture comprising reb A and from about 60 wt % to about 50 wt % mogroside V; and about 50 wt % of the steviol glycoside mixture comprising reb A and about 50 wt % mogroside V.

C. Siamenoside I-Containing blends

In some embodiments, a blend of the present invention contains reb M and siamenoside I. In one aspect, a blend comprises (i) from about 20 wt % to about 70 wt % of a steviol glycoside mixture comprising reb M and (ii) from about 30 wt % to about 80 wt % siamenoside I. In another aspect, a blend comprises (i) from about 20 wt % to about 70 wt % of a steviol glycoside mixture comprising reb A and (ii) from about 30 wt % to about 80 wt % siamenoside I.

The blends can further comprise other steviol glycosides including, but not limited to, reb A, reb M, reb B, reb C, reb G, reb N, reb D, reb E, reb O, reb J, isorebM, reb I and combinations thereof. Unless specified otherwise, the purity of the reb and/or siamenoside I is at least about 90% by weight, such as, for example, at least about 95% by weight.

The blends of the present invention containing reb M and siamenoside I exhibit reduced foaming during bottling compared to (i) a blend of only the steviol glycoside mixture comprising reb M, e.g. 95% reb M or RebM80 and/or (ii) the blend without siamenoside I. That is, when the blends are formulated into concentrates or beverage syrups at 0.25 wt %-0.4 wt % and subsequently diluted to beverages, beverages prepared from concentrates or beverage syrups containing blends of the present invention exhibit reduced foaming compared to a corresponding beverage sweetened with (i) a blend of only the steviol glycoside mixture comprising reb M, e.g. 95% reb M or RebM80 and/or (ii) the blend without siamenoside I.

The blends of the present invention containing reb A and siamenoside I exhibit reduced foaming during bottling compared to (i) a blend of only the steviol glycoside mixture comprising reb A and/or (ii) the blend without siamenoside I. That is, when the blends are formulated into concentrates or beverage syrups at 0.25 wt %-0.4 wt % and subsequently diluted to beverages, beverages prepared from concentrates or beverage syrups containing blends of the present invention exhibit reduced foaming compared to a corresponding beverage sweetened with (i) a blend of only the steviol glycoside mixture comprising reb A and/or (ii) the blend without siamenoside I.

Methods of measuring foam height and foam diminish time are described above and known in the art. Beverages prepared from concentrates or beverage syrups containing blends comprising reb M and siamenoside I exhibit foam diminish time that is at least about 5% less, at least about 10% less, at least about 20% less or at least about 40% less compared to a corresponding beverage sweetened with a blend of only the steviol glycoside mixture comprising reb M, e.g. 95% reb M or RebM80. Beverages prepared from concentrates or beverage syrups containing blends comprising reb A and siamenoside I exhibit foam diminish time that is at least about 5% less, at least about 10% less, at least about 20% less or at least about 40% less compared to a corresponding beverage sweetened with a blend of only the steviol glycoside mixture comprising reb A.

One diblend of the present invention comprises (i) a steviol glycoside mixture comprising reb M and (ii) siamenoside I. In a more particular embodiment, the diblend consists essentially of (i) a steviol glycoside mixture comprising reb M and (ii) siamenoside I. In a still further particular embodiment, the diblend consists of (i) a steviol glycoside mixture comprising reb M and (ii) siamenoside I.

The relative amounts of the steviol glycoside mixture comprising reb M and siamenoside I influence foaming. Preferably, the diblend comprises from about 20 wt % to about 70 wt % of the steviol glycoside mixture comprising reb M and from about 30 wt % to about 80 wt % siamenoside I, such as, for example, from about 20 wt % to about 60 wt % of the steviol glycoside mixture comprising reb M and about 80 wt % to about 40 wt % siamenoside I; from about 20 wt % to about 50 wt % of the steviol glycoside mixture comprising reb M and from about 80 wt % to about 50 wt % siamenoside I; from about 20 wt % to about 40 wt % of the steviol glycoside mixture comprising reb M and from about 80% to about 60 wt % siamenoside I; from about 20 wt % to about 30 wt % of the steviol glycoside mixture comprising reb M and from about 80 wt % to about 70 wt % siamenoside I; from about 30 wt % to about 70 wt % of the steviol glycoside mixture comprising reb M and from about 70 wt % to about 30 wt % siamenoside I; from about 30 wt % to about 60 wt % of the steviol glycoside mixture comprising reb M and about 70 wt % to about 40 wt % siamenoside I; from about 30 wt % to about 50 wt % of the steviol glycoside mixture comprising reb M and from about 70 wt % to about 50 wt % siamenoside I; from about 30 wt % to about 40 wt % of the steviol glycoside mixture comprising reb M and about 70 wt % to about 60 wt % siamenoside I; from about 40 wt % to about 70 wt % of the steviol glycoside mixture comprising reb M and from about 60 wt % to about 30 wt % siamenoside I; from about 40 wt % to about 60 wt % of the steviol glycoside mixture comprising reb M and from about 60 wt % to about 40 wt % siamenoside I; from about 40 wt % to about 50 wt % of the steviol glycoside mixture comprising reb M and from about 60 wt % to about 50 wt % siamenoside I; and about 50 wt % of the steviol glycoside mixture comprising reb M and about 50 wt % siamenoside I.

Another diblend of the present invention comprises (i) a steviol glycoside mixture comprising reb A and (ii) siamenoside I. In a more particular embodiment, the diblend consists essentially of (i) a steviol glycoside mixture comprising reb A and (ii) siamenoside I. In a still further particular embodiment, the diblend consists of (i) a steviol glycoside mixture comprising reb A and (ii) siamenoside I.

The relative amounts of the steviol glycoside mixture comprising reb A and siamenoside I influence foaming. Preferably, the diblend comprises from about 20 wt % to about 70 wt % of the steviol glycoside mixture comprising reb A and from about 30 wt % to about 80 wt % siamenoside I, such as, for example, from about 20 wt % to about 60 wt % of the steviol glycoside mixture comprising reb A and about 80 wt % to about 40 wt % siamenoside I; from about 20 wt % to about 50 wt % of the steviol glycoside mixture comprising reb A and from about 80 wt % to about 50 wt % siamenoside I; from about 20 wt % to about 40 wt % of the steviol glycoside mixture comprising reb A and from about 80% to about 60 wt % siamenoside I; from about 20 wt % to about 30 wt % of the steviol glycoside mixture comprising reb A and from about 80 wt % to about 70 wt % siamenoside I; from about 30 wt % to about 70 wt % of the steviol glycoside mixture comprising reb A and from about 70 wt % to about 30 wt % siamenoside I; from about 30 wt % to about 60 wt % of the steviol glycoside mixture comprising reb A and about 70 wt % to about 40 wt % siamenoside I; from about 30 wt % to about 50 wt % of the steviol glycoside mixture comprising reb A and from about 70 wt % to about 50 wt % siamenoside I; from about 30 wt % to about 40 wt % of the steviol glycoside mixture comprising reb A and about 70 wt % to about 60 wt % siamenoside I; from about 40 wt % to about 70 wt % of the steviol glycoside mixture comprising reb A and from about 60 wt % to about 30 wt % siamenoside I; from about 40 wt % to about 60 wt % of the steviol glycoside mixture comprising reb A and from about 60 wt % to about 40 wt % siamenoside I; from about 40 wt % to about 50 wt % of the steviol glycoside mixture comprising reb A and from about 60 wt % to about 50 wt % siamenoside I; and about 50 wt % of the steviol glycoside mixture comprising reb A and about 50 wt % siamenoside I.

III. Concentrates and Methods of Preparing Same

The present invention also provides super concentrates and concentrates comprising the blends described above.

The super concentrates have blend concentrations of about 1 wt % to about 10 wt %, such as, for example, about 2 wt %, about 3 wt %, about 4 wt %, about 5 wt %, about 6 wt %, about 7 wt %, about 8 wt %, about 9 wt and any range between. In a particular embodiment, the super concentrate has a blend concentration from about 2 wt % to about 5 wt %.

The concentrates have blend concentrations of about 0.25 wt % or more, such as, for example, at least about 0.3 wt %, 0.4 wt %, at least about 0.5 wt % or at least about 1.0 wt %. In one embodiment, the concentrates have blend concentrations from about 0.25 wt % to about 0.4 wt %. The concentrates are solutions, i.e. they are not cloudy and there are no particulates present.

The concentrates are prepared from the super concentrate. The super concentrate is prepared by (i) combining the relevant blend of the present invention and water at room temperature to provide a mixture (both the blend of the present invention and water are present in amounts necessary to provide the desired concentration/wt %) and (ii) stirring the mixture at room temperature for at least 10 minutes. The stirring time can vary depending on the amounts of both blend and water used. As such, the mixture can be stirred for at least 1 hour, at least 3 hours, at least 5 hours, at least 10 hours or at least 24 hours. The resulting super concentrate is a cloudy mixture, i.e. not a solution.

The concentrates of the present invention are prepared by (i) diluting the super concentrate to the desired concentration/wt % with water and (ii) mixing for at least 10 minutes. Again, the mixing time can vary. As such, the mixture can be stirred for at least 1 hour, at least 24 hours or at least 90 hours.

The resulting concentrate is clear by visual inspection, i.e. no particulate material is observed for at least about 6 hours after preparing. In some embodiments, the concentrate is clear by visual inspection for at least 1 day, at least 4 days, at least 14 days or at least one month.

Concentrates containing blends of the present invention at 0.25 wt %-0.4 wt % exhibit superior aqueous solubility. In one embodiment, the concentrates exhibit superior solubility compared to concentrates containing only the steviol glycoside mixture. In one embodiment, a concentrate of the present invention has an aqueous solubility that is at least about 1.5× more than the aqueous solubility of a concentrate of only the steviol glycoside mixture, such as, for example, at least about 1.7× more or least about 2.0× more.

Concentrates containing blends of the present invention at 0.25 wt %-0.4 wt % exhibit superior aqueous solubility concentrates containing the blend without reb N. In one embodiment, a concentrate of the present invention has an aqueous solubility that is at least about 1.5× more than the aqueous solubility of a concentrate of the blend without reb N, such as, for example, at least about 1.7× more or least about 2.0× more.

Concentrates containing blends of the present invention also exhibit similar (non-statistically different) taste profiles to concentrates containing the steviol glycoside mixture when formulated into beverages. That is, beverages prepared from concentrates of the present invention have a similar taste profile to a corresponding beverage prepared with the steviol glycoside mixture comprising reb M, e.g. 95% reb M or RebM80. For example, beverages of the instant invention have one or more of the same attributes as the corresponding beverage containing just the steviol glycoside mixture comprising reb M: sweetness, sweetness linger, bitterness, licorice flavor, mouthfeel, temporal profile, sweetness onset, etc. Methods of determining these attributes are well-known to those of skill in the art.

In some embodiments, concentrates containing blends of the present invention also exhibit reduced foaming during bottling compared to concentrates containing (i) only the steviol glycoside mixture c and/or (ii) reb A and/or (iii) the blend without reb N, mogroside V or siamenoside I (depending on the blend). Beverages prepared from concentrates of the present invention exhibit foam diminish time that is at least about 5% less, at least about 10% less, at least about 20% less or at least about 40% less compared to a corresponding beverage prepared from a concentrate containing (i) only the steviol glycoside mixture and/or (ii) reb A and/or (iii) the blend without reb N, mogroside V or siamenoside I (depending on the blend).

It should be noted that the reduced foaming does not apply to concentrates containing reb B in significant (i.e. not trace) amounts.

IV. Beverage Syrup and Method of Making Same

The present invention also provides beverage syrups prepared using the concentrate described herein and methods for making beverage syrups.

In one embodiment, a method of making a beverage syrup comprises combining beverage syrup ingredients with the concentrate. In one embodiment, the beverage syrup ingredients are added to a concentrate to provide a beverage syrup.

In other embodiments, the concentrate can be diluted prior to combination with beverage syrup ingredients. The dilution can be done at once or in a serial fashion. The temperature for dilution is preferably the same temperature at which the beverage syrup ingredients are formulated, typically room temperature—but not above about 70° C. for steviol glycosides or other thermally sensitive ingredients.

The skilled practitioner recognizes that beverage syrup ingredients can be added singularly or in combination. Also, solutions of dry beverage syrup ingredients can be made and used to add to the bulk quantity of water. Beverage syrup ingredients typically are added to the bulk quantity of water in an order that minimizes potential adverse interactions between ingredients or potential adverse effect on an ingredient. For example, nutrients that are temperature-sensitive might be added during a relatively low-temperature portion toward the end of the manufacturing process. Similarly, flavors and flavor compounds often are added just before completion of the syrup to minimize potential loss of volatile components and to minimize flavor loss in any form. Often, acidification is one of the last steps, typically carried out before temperature-sensitive, volatile, and flavor materials are added. Thus, flavors or flavor components or other volatile materials and nutrients typically are added at an appropriate time and at an appropriate temperature.

Beverage syrup ingredients include, but are not limited to, additional sweeteners, functional ingredients and additives.

The additional sweetener can be a natural sweetener, a natural high potency sweetener or synthetic sweetener.

As used herein, the phrase “natural high potency sweetener” refers to any sweetener found naturally in nature and characteristically has a sweetness potency greater than sucrose, fructose, or glucose, yet has less calories. The natural high potency sweetener can be provided as a pure compound or, alternatively, as part of an extract. As used herein, the phrase “synthetic sweetener” refers to any composition which is not found naturally in nature and characteristically has a sweetness potency greater than sucrose, fructose, or glucose, yet has less calories.

In one embodiment, the sweetener is a carbohydrate sweetener. Suitable carbohydrate sweeteners include, but not limited to, the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable sweeteners include siamenoside, monatin and its salts (monatin SS, RR, RS, SR), curculin, mogrosides, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

In one embodiment, the sweetener is a caloric sweetener or mixture of caloric sweeteners. In another embodiment, the caloric sweetener is selected from sucrose, fructose, glucose, high fructose corn/starch syrup, a beet sugar, a cane sugar, and combinations thereof.

In another embodiment, the sweetener is a rare sugar selected from allulose, gulose, kojibiose, sorbose, lyxose, ribulose, xylose, xylulose, D-allose, L-ribose, D-tagatose, L-glucose, L-fucose, L-arabinose, turanose and combinations thereof.

The amount of additional sweetener in the beverage syrup can vary. In one embodiment, the beverage syrup comprises from about 1 ppm to about 10 wt % additional sweetener.

Exemplary functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

In certain embodiments, the functional ingredient is at least one saponin. As used herein, the at least one saponin may comprise a single saponin or a plurality of saponins. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponaria), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is reservatrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, Md.), OmegaPure (from Omega Protein, Houston, Tex.), Marinol C-38 (from Lipid Nutrition, Channahon, Ill.), Bonito oil and MEG-3 (from Ocean Nutrition, Dartmouth, NS), Evogel (from Symrise, Holzminden, Germany), Marine Oil, from tuna or salmon (from Arista Wilton, Conn.), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is at least one vitamin. Suitable vitamins include, vitamin A, vitamin D, vitamin E, vitamin K, vitamin B 1, vitamin B2, vitamin B3, vitamin B5, vitamin B6, vitamin B7, vitamin B9, vitamin B12, and vitamin C.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof In other embodiments, the vitamin is a water-soluble vitamin chosen from vitamin B 1, vitamin B2, vitamin B3, vitamin B6, vitamin B12, folic acid, biotin, pantothenic acid, vitamin C and combinations thereof.

In certain embodiments, the functional ingredient is glucosamine, optionally further comprising chondroitin sulfate.

In certain embodiments, the functional ingredient is at least one mineral. Minerals, in accordance with the teachings of this invention, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In one embodiment, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In a particular embodiment, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in one embodiment, the minerals may be in their ionic form, having either a positive or negative charge. In another embodiment, the minerals may be in their molecular form. For example, sulfur and phosphorous often are found naturally as sulfates, sulfides, and phosphates.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In a particular embodiment, the hydration agent is an electrolyte. Non-limiting examples of electrolytes include sodium, potassium, calcium, magnesium, chloride, phosphate, bicarbonate, and combinations thereof. Suitable electrolytes for use in particular embodiments of this invention are also described in U.S. Patent No. 5,681,569. In one embodiment, the electrolyte is obtained from the corresponding water-soluble salt. Non-limiting examples of salts include chlorides, carbonates, sulfates, acetates, bicarbonates, citrates, phosphates, hydrogen phosphates, tartrates, sorbates, citrates, benzoates, or combinations thereof. In other embodiments, the electrolyte is provided by juice, fruit extracts, vegetable extracts, tea, or tea extracts.

In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside III, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T. officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium soucrce. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen-like effect of any degree. For example, a phytoestrogen may bind to estrogen receptors within the body and have a small estrogen-like effect.

Examples of suitable phytoestrogens for embodiments of this invention include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (-OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom 1-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethylsterols (e.g., β-sitosterol, campesterol, stigmasterol, brassicasterol, 22-dehydrobrassicasterol, and Δ5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the α and β isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

The amount of functional ingredient in the beverage syrup can vary. In one embodiment, the beverage syrup comprises from about 1 ppm to about 10 wt % of a functional ingredient.

Exemplary additives include, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and combinations thereof.

In one embodiment, the syrup further comprises one or more polyols. The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, N.J., U.S.A.), and Sucramask™ (Creative Research Management, Stockton, Calif., U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like.

Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

The amount of additive in the beverage syrup can vary. In one embodiment, the beverage syrup comprises from about 1 ppm to about 10 wt % of an additive.

The pH of the beverage syrup is typically from about 2.0 to about 5, such as, for example, from about 2.5 to about 4. The pH may be adjusted by addition of a suitable acid or base such as, but not limited to phosphoric acid, citric acid, or sodium hydroxide.

The resulting beverage syrup is packaged and may be stored. A beverage syrup may be used essentially immediately to manufacture beverages, which typically are packaged for distribution. A beverage syrup also may be distributed to bottlers, who package beverages made by addition of water and perhaps other materials like carbonation.

The beverage syrup can be a full-calorie beverage syrup such that a ready-to-drink beverage prepared from the beverage syrup has up to about 120 calories per 8 oz serving.

The beverage syrup can be a mid-calorie beverage syrup, such that a ready-to-drink beverage prepared from the beverage syrup has up to about 60 calories per 8 oz. serving.

The beverage syrup can be a low-calorie beverage syrup, such that a ready-to-drink beverage prepared from the beverage syrup has up to about 40 calories per 8 oz. serving.

The beverage syrup can be a zero-calorie beverage syrup, such that a ready-to-drink beverage prepared from the beverage syrup has less than about 5 calories per 8 oz. serving.

Beverages prepared from beverage syrups of the present invention have a similar taste profile to a corresponding beverage prepared with the steviol glycoside mixture comprising reb M, e.g. 95% reb M or RebM80. For example, beverages of the instant invention have one or more of the same attributes as the corresponding beverage containing just the steviol glycoside mixture comprising reb M: sweetness, sweetness linger, bitterness, licorice flavor, mouthfeel, temporal profile, sweetness onset, etc. Methods of determining these attributes are well-known to those of skill in the art.

In some embodiments, beverage syrups containing blends of the present invention exhibit reduced foaming during bottling compared to beverage syrups containing (i) only the steviol glycoside and/or (ii) reb A and/or (iii) the blend without reb N, mogroside V or siamenoside.

V. Beverages and Method of Making Same

The present invention also provides ready-to-drink beverages prepared from the beverage syrups described herein and methods of preparing ready-to-drink beverages. In some embodiments, the beverage syrup is a concentrate of the present invention, i.e. without additional beverage ingredients.

Ready-to-drink beverages include carbonated and non-carbonated beverages.

Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer.

Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, dairy beverage, beverage containing milk components (e.g. milk beverages, coffee containing milk components, café au lait, milk tea, fruit milk beverages), beverages containing cereal extracts and smoothies.

A method of preparing a beverage comprises mixing a beverage syrup described herein with an appropriate quantity of diluting water.

Typically, the volumetric ratio of syrup to water is between 1:3 to 1:8, such as, for example, between 1:3 and 1:8, between 1:3 and 1:7, between 1:3 and 1:6, between 1:3 and 1:5, between 1:3 and 1:4, between 1:4 and 1:8, between 1:4 and 1:7, between 1:4 and 1:6, between 1:4 and 1:5, between 1:5 and 1:8, between 1:5 and 1:7, between 1:5 and 1:6, between 1:6 and 1:8, between 1:6 and 1:7 and between 1:7 and 1:8. In a particular embodiment, the volumetric ration of syrup to water is about 1:5.5.

The temperature at which the mixing is done is preferably under about 70 ° C. to minimize degradation of steviol glycosides.

In one embodiment, the beverage is a carbonated beverage (e.g. fountain drink or soft drink) and the diluting water is carbonated water. The beverage is typically dispensed for immediate consumption.

Other types of water typical in beverage manufacturing and be used to prepare beverages, e.g. deionized water, distilled water, reverse osmosis water, carbon-treated water, purified water, demineralized water and combinations thereof.

The concentrate and beverage syrups of the instant invention can be formulated into beverages by typical equipment found in a bottling facility. No skids for solubilizing reb M are needed.

Beverages contain steviol glycoside blends of the present invention in concentrations from about 50 ppm to about 1,000 ppm, such as, for example, from about 100 ppm to about 600 ppm, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, or from about 300 ppm to about 400 ppm.

In particular embodiments, beverages contain relatively high concentrations steviol glycoside blends, i.e. from about 400 ppm to about 600 ppm of the blend, such as, for example, from about 400 ppm to about 500 ppm, from about 500 ppm to about 600 ppm or from about 550 to about 600 ppm.

Beverages of the present invention exhibit similar (non-statistically different) taste profiles to beverages containing a blend of only the steviol glycoside mixture comprising reb M, e.g. 95% reb M or RebM80. For example, beverages of the instant invention have one or more of the same attributes as the corresponding beverage containing just the steviol glycoside mixture comprising reb M: sweetness, sweetness linger, bitterness, licorice flavor, mouthfeel, temporal profile, sweetness onset, etc. Methods of determining these attributes are well-known to those of skill in the art.

The beverage can be a full-calorie beverage that has up to about 120 calories per 8 oz serving.

The beverage can be a mid-calorie beverage that has up to about 60 calories per 8 oz. serving.

The beverage can be a low-calorie beverage that has up to about 40 calories per 8 oz. serving.

The beverage can be a zero-calorie that has less than about 5 calories per 8 oz. serving.

In a particular embodiment, the beverage is a diet beverage, i.e. a low-calorie or zero-calories beverage. In a more particular embodiment, the beverage is a diet carbonated beverage. Particularly desirable diet carbonated beverages are cola beverages and lemon-lime flavored beverages.

In one embodiment, the present invention provides a diet carbonated beverage comprising a blend of the present invention in a concentration from about 400 ppm to about 600 ppm, or from about 500 ppm to about 600 ppm.

In some embodiments, the beverage is a carbonated beverage wherein the blend of the present invention is the only sweetener, i.e. the only substance that provides detectable sweetness. Such carbonated beverages, e.g. colas, are zero-calorie.

V. Methods

The present invention also provides a method of improving the aqueous solubility of a steviol glycoside blend comprising reb M comprising substituting some portion of the steviol glycoside blend comprising reb M with reb N. For example, from about 20 wt % to about 80% of the steviol glycoside mixture comprising reb M can be replaced with reb N, such as, for example, from about 30 wt % to about 60 wt %, from about 30 wt % to about 50 wt % or from about 40 wt % to about 60 wt %.

The present invention also provides a method of reducing foaming (foam height and/or foam diminish time) of a beverage comprising a steviol glycoside blend comprising reb M or reb A, comprising substituting of some portion of the steviol glycoside blend comprising reb M with a compound selected from the group consisting of reb N, mogroside V, siamenoside I and a combination thereof. For example, from about 20 wt % to about 80% of the steviol glycoside mixture comprising reb M or reb A can be substituted, such as, for example, from about 20 wt % to about 70 wt %, from about 20 wt % to about 60 wt %, from about 20 wt % to about 50 wt %, from about 20 wt % to about 40 wt %, from about 20 wt % to about 30 wt %, from about 30 wt % to about 80 wt %, from about 30 wt % to about 70 wt %, from about 30 wt % to about 60 wt %, from about 30 wt % to about 50 wt %, from about 30 wt % to about 40 wt %, from about 40 wt % to about 80 wt %, from about 40 wt % to about 70 wt %, from about 40 wt % to about 60 wt %, from about 40 wt % to about 50 wt %, from about 50 wt % to about 80 wt %, from about 50 wt % to about 70 wt %, from about 50 wt % to about 60 wt %, from about 60 wt % to about 80 wt %, from about 60 wt % to about 70 wt % and from about 70 wt % to about 80 wt %.

Foam diminish time for a beverage comprising a blend of the present invention is at least 5% less than a beverage without the rebaudioside N, mogroside V and/or siamenoside I, such as, for example, at least about 10% less, at least about 20% less, at least about 30% less, at least about 40% less or at least about 50% less. Foam height for a beverage comprising a blend of the present invention is at least 5% less than a beverage without the rebaudioside N, mogroside V and/or siamenoside I, such as, for example, at least about 10% less, at least about 20% less, at least about 30% less, at least about 40% less or at least about 50% less.

### EXAMPLES

In the following examples, “RebM80” refers to a steviol glycoside mixture containing at least 80% Reb M by weight (the majority of the remainder is Reb D and Reb A). The total steviol glycoside content of the mixture is at least 95%.

### Example 1

### Triblends of RebM80, Reb A and Reb N

Super concentrates containing 2 wt % steviol glycoside content were prepared by combining RebM80, reb A and reb N in the amounts indicated below with water at room temperature. The mixtures were mixed for one hour, providing cloudy mixtures.

TABLE 1
Triblend 2 wt % Super Concentrates

| | RebM80/ | RebM80/ |
|---|---|---|
| | Reb A/ | RebA/ |
| | Reb N weight | Reb N weight |
| Sample | ratio | percent |
| 1 | 3/0/7 | 0.6%/0%/1.4% |
| 2 | 4/0/6 | 0.8%/0%/1.2% |
| 3 | 4.5/0/5.5 | 0.9%/0%/1.1% |
| 4 | 4.5/1.0/4.5 | 0.9%/0.2%/0.9% |
| 5 | 4.5/1.5/4.0 | 0.9%/0.3%/0.8% |
| 6 | 5/0/5 | 1.0%/0%/5% |

The 2 wt % super concentrates were then diluted to a 5.5+1 syrup concentration (0.3 wt %) with water and mixed at room temperature for 90 hours, providing clear solutions. The final syrup concentrations are provided below:

TABLE 2
Triblend Syrup Concentrations (0.3 wt %)

| | RebM80/ | RebM80/ |
|---|---|---|
| | Reb A/ | Reb A/ |
| | Reb N weight | Reb N weight |
| Sample | ratio | percent |
| 1 | 3/0/7 | 0.09%/0%/0.21% |
| 2 | 4/0/6 | 0.12%/0%/0.18% |
| 3 | 4.5/0/5.5 | 0.135%/0%/0.165% |
| 4 | 4.5/1.0/4.5 | 0.135%/0.3%/0.135% |
| 5 | 4.5/1.5/1.0 | 0.135%/0.4%/0.120% |
| 6 | 5/0/5 | 0.15%/0%/0.15% |

### Example 2

### Diblends of RebM80 and Reb N

Super concentrates containing 2 wt % steviol glycoside content were prepared by combining the RebM80 and reb N in the amounts indicated below with water. The mixtures were mixed for one hour, providing cloudy mixtures.

TABLE 3
Diblend 2 wt % Super Concentrates

| | RebM80/ | RebM80/ |
|---|---|---|
| | Reb N weight | Reb N weight |
| Sample | ratio | percent |
| 1 | 0/1 | 0%/2.0% |
| 2 | 2/8 | 0.4%/1.6% |
| 3 | 3/7 | 0.6%/1.4% |
| 4 | 4/6 | 0.8%/1.2% |
| 5 | 4.5/5.5 | 0.9%/1.1% |
| 6 | 5/5 | 1.0%/1.0% |
| 7 | 4/6 | 1.2%/0.8% |
| 8 | 7/3 | 1.4%/0.6% |
| 9 | 1/0 | 2.0%/0% |

The 2 wt % super concentrates were then diluted to a 5.5+1 syrup concentration (0.3 wt %) with water and mixed at room temperature for 90 hours. The final syrup concentrations are provided below:

TABLE 4
Diblend Syrup Concentrations (0.3 wt %)

| | RebM80/ | RebM80/ | |
|---|---|---|---|
| | Reb N weight | Reb N weight | |
| Sample | ratio | percent | Observations |
| 1 | 0/1 | 0.0%/0.3% | Cloudy/precipitation |
| 2 | 2/8 | 0.06%/0.24% | Clear Solution |
| 3 | 3/7 | 0.09%/0.21% | Clear Solution |
| 4 | 4/6 | 0.12%/0.18% | Clear Solution |
| 5 | 4.5/5.5 | 0.135%/0.165% | Clear Solution |
| 6 | 5/5 | 0.15%/0.15% | Clear Solution |
| 7 | 4/6 | 0.18%/0.12% | Clear Solution |
| 8 | 7/3 | 0.21%/0.09% | Cloudy/precipitation |
| 9 | 1/0 | 0.3%/0% | Cloudy/precipitation |

As can be seen from Table 4, use of Reb N or RebM80 only leads to cloudy 0.3 wt % syrup concentrates. The sample containing 70% RebM80 also led to a cloudy 0.3 wt % syrup concentrate.

### Example 3

### Solubility, Taste Profile and Defoaming of Stevia Blends of the Present Invention

The sensory profiles of beverages (citric acid buffer matrix) sweetened with the blends identified in Table 5 were compared to beverages sweetened with either reb A only or reb M only. The foaming of beverages sweetened with the blends was also studied.

TABLE 5

| | 1 | 2 | 3 | 4 | 5 | 6 | 7 |
|---|---|---|---|---|---|---|---|
| Ingredient | Reb A | Reb M | Reb D, E, | Reb D, M, | Reb A, M, | Reb D, M, | Reb D, M, |
| Name | only | 95% *** | M, N Blend | N Blend | N Blend | N, O Blend | N, O Blend |
| Reb A | 500 | | | | 75 ppm | | |
| | | | | | (15%) | | |
| Reb D | | | 45 ppm | 25 ppm | | 45 ppm | 45 ppm |
| | | | (10%) | (5%) | | (10%) | (10%) |
| Reb E | | | 65 ppm | | | | |
| | | | (13%) | | | | |
| Reb N | | | 200 ppm | 250 ppm | 200 ppm | 180 ppm | 190 ppm |
| | | | (40%) | (50%) | (40%) | (36%) | (38%) |
| Reb M 95% | | 500 | 190 ppm | 225 (45%) | 225 ppm | 180 ppm | 220 ppm |
| | | | (38%) | | (45%) | (36%) | (44%) |
| Reb O | | | | | | 95 ppm | 45 ppm |
| | | | | | | (19%) | (10%) |
| total | | | 500 | 500 | 500 | 500 | 500 |
| Taste profile | Poor | Good | Good | Good | Good | Good | Good |
| Solubility at | Soluble | Not | soluble | soluble | soluble | soluble | soluble |
| different syrup | | soluble | | | | | |
| throw ratios- 4.4 + 1, | | | | | | | |
| 5 + 1, 5.5 + 1 | | | | | | | |
| Foam Height* | 403.33 | 383.3 | 406.7 | 410 | 393.3 | 383.3 | 396.7 |
| Foam Diminish | 22.33 | 14.67 | 11.7 | 10.3 | 13.7 | 14.7 | 13.7 |
| Time** | | | | | | | |

*Foam height was measured (in mL) when the level of foam becomes uniform throughout the circumference of the beaker into which each sample was poured into
**Foam diminishing time was measured between the time when each sample hit the bottom of the beaker and the level of the entire sample hit 350 mL line
*** Both RebM80 and 95% Reb M were evaluated and exhibited similar results

### Example 4

### Sensory Data

Steviol glycosides with high purity (>95%), namely Rebaudioside A, B, D, N, M, and O were evaluated in acidified citric buffer, a lemon lime and a cola carbonated beverage at concentration of 500 ppm in finished beverage.

1.1 Mock Beverage (Citric Acid Buffer)

Filtered water was used to dissolve the individual steviol glycosides as well as the blends to deliver a total steviol glycoside concentration of 500 ppm.

Samples were served and evaluated at ambient temperature.

| Ingredients | Amount (%) |
|---|---|
| Filtered water | 99.7 |
| Citric acid | 0.117 |
| Sodium citrate | 0.027 |
| Sodium benzoate | 0.018 |
| Steviol glycosides | 0.05 |
| TOTAL | 100 |

1.2. Lemon-Lime Carbonated Beverage

The following table shows the ingredients and their amount in the lemon lime syrup (5.5+1)

| Ingredients | Amount (%) |
|---|---|
| Filtered water | 98.05 |
| Citric acid | 0.76 |
| Sodium citrate | 0.178 |
| Sodium benzoate | 0.12 |
| Lemon lime flavor | 0.5655 |
| Steviol glycosides | 0.325 |
| TOTAL | 100 |

The ingredients were dissolved in filtered water to constitute a syrup, then the final beverage was made by weighing the appropriate syrup amount and adding carbonated water using a ratio of 1 part syrup+5.5 parts carbonated water. Final beverages were filled in 300 ml glass bottles then aged for 3 days at 35° C. before they were cooled and served cold (4° C.). The control with Reb-M was made by heating water up to around 47° C. then dissolving Reb-M. After complete dissolution, the concentrated Reb-M solution was cooled down to ambient temperature before the rest of the ingredients were added. The other blends were soluble in syrup system and did not need any heating.

1.3. Cola Carbonated Beverage

The following table shows the ingredients and their amount in the cola syrup (5.5 +1)

| Ingredients | Amount (%) |
|---|---|
| Filtered water | 98.06 |
| Caramel | 1.105 |
| Phosphoric acid | 0.13 |
| Citric acid | 0.065 |
| Potassium sorbate | 0.0585 |
| Sodium benzoate | 0.009 |
| Caffeine | 0.052 |
| Cola flavor | 0.195 |
| Steviol glycosides | 0.325 |
| TOTAL | 100 |

The ingredients were dissolved in filtered water to constitute a syrup, then the final beverage was made by weighing the appropriate syrup amount and adding carbonated water using a ratio of 1 part syrup+5.5 parts carbonated water. Final beverages were filled in 300 ml glass bottles then aged for 3 days at 35° C. before they were cooled and served cold (4° C.). The control with Reb-M was made by heating water up to around 47° C. then dissolving Reb-M. After complete dissolution, the concentrated Reb-M solution was cooled down to ambient temperature before the rest of the ingredients were added. The other blends were soluble in syrup system and did not need any heating.

2. Sensory Evaluation

The beverages were evaluated blindly by at least 5 expert panelists who work and taste steviol glycosides sweetened beverages on a daily basis. Samples were coded and randomly presented to the panelists. Panelists were instructed to eat an unsalted cracker and rinse the mouth with water before and in between samples. The maximum samples for each session was set at 5 samples to avoid fatigue. For each sample, panelists were instructed to take 3 sips, then write down their evaluation comments. Mock beverages were tasted at ambient temperature while carbonated beverages (diet lemon lime and cola) were tasted at 4° C.

2.1. Sensory Evaluation for Mock Beverage

The following table shows the steviol glycosides in blends at different levels (ppm), their solubility in mock syrup and the panelist comments after blind taste tasting.

| | Concentration | Solubility in | |
|---|---|---|---|
| Steviol Glycosides | (ppm) in citric | Syrup System | |
| Blends (ppm, wt %) | buffer | (0.3%) | Panelists Comments |
| Reb-M | 500 ppm | No | Nice upfront sweetness, |
| | | | slight sweet lingering, |
| | | | slight bitterness |
| Reb-M | 512 ppm | No | Nice upfront sweetness, |
| | | | slight sweet lingering, |
| | | | slight bitterness |
| Reb-A (165 ppm, 33%) + | 500 ppm | Yes | Slight sweetness lingering |
| Reb-B (80 ppm, 16%) + | | | and bitterness, slightly |
| Reb-M (255 ppm, 51%) | | | less sweet than |
| | | | Reb-M alone |
| Reb-A (165 ppm, 33%) + | 500 ppm | Yes | Very clean sweetness, no |
| Reb-B (80 ppm, 16%) + | | | aftertaste, overall less |
| Reb-N (255 ppm, 51%) | | | sweet than Reb-M alone |
| Reb-A (170 ppm, 34%) + | 500 ppm | Yes | Slight sweetness lingering |
| Reb-B (90 ppm, 18%) + | | | and bitterness, overall |
| Reb-D (30 ppm, 6%) + | | | sweetness comparable to |
| Reb-M (210 ppm, 42%) | | | Reb-M alone |
| Reb-A (155 ppm, 31%) + | 500 ppm | Yes | Sweeter and smoother than |
| Reb-B (90 ppm, 18%) + | | | other blends containing Reb-A, |
| Reb-D (45 ppm, 9%) + | | | much preferred over other blends |
| Reb-M (210 ppm, 42%) | | | containing Reb-A, sweetness |
| | | | comparable to Reb-M alone, |
| | | | some sweetness lingering |
| reb-A (175 ppm, 34%) + | 560 ppm | Yes | Sweeter and smoother than |
| Reb-B (95 ppm, 18%) + | | | other blends containing Reb-A, |
| Reb-D (45 ppm, 6%) + | | | much preferred over other blends |
| Reb-M (200 ppm, 42%) | | | containing Reb-A, sweetness |
| | | | comparable to Reb-M alone, much |
| | | | less sweet linger than Reb M alone |
| Reb-A (170 ppm, 31%) + | 550 ppm | Yes | Sweeter and smoother than |
| Reb-B (90 ppm, 18%) + | | | other blends containing Reb-A, |
| Reb-D (45 ppm, 9%) + | | | much preferred over other blends |
| Reb-M (220 ppm, 42%) | | | containing Reb-A, sweetness |
| | | | comparable to Reb-M alone, much |
| | | | less sweet linger than Reb M alone |
| Reb-B (100 ppm, 20%) + | 500 ppm | Yes | Very clean sweet taste, no |
| Reb-D (30 ppm, 6%) + | | | bitterness, no aftertaste, |
| Reb-M (180 ppm, 36%) + | | | preferred over Reb-M alone |
| Reb-N (190 ppm, 38%) | | | |
| Reb-B (100 ppm, 20%) + | 500 ppm | Yes | Very clean sweet taste, no |
| Reb-M (190 ppm, 38%) + | | | bitterness, no aftertaste, |
| Reb-N (210 ppm. 42%) | | | preferred over Reb-M alone |
| Reb-D (45 ppm, 9%) + | 500 ppm | Yes | Nice sweetness profile, |
| Reb-M (220 ppm, 44%) + | | | slightly sweetness lingering |
| Reb-N (190 ppm, 38%) + | | | compared to Reb-M alone |
| Reb-O (45 ppm, 9%) | | | |

From the panelist comments, it can clearly be seen that the blends show an acceptable overall taste profile, with some showing even cleaner taste compared with the Reb-M alone.

2.2. Sensory Evaluation for Diet Lemon Lime Carbonated Beverage

The following table shows the steviol glycosides in blends at different levels (ppm), the panelist ratings (1=most preferred, 5=least preferred) as well as the panelist comments.

| | Concentration | | |
|---|---|---|---|
| | (ppm) in | Average Panelist Rating | |
| Steviol Glycosides | Finished | (1 = most preferred, | |
| Blends | Beverage | 5 = least preferred) | Panelists Comments |
| Reb-M | 500 ppm | 4.1 | Good upfront sweetness, |
| | | | slightly watery, less bitter |
| Reb-M | 512 ppm | 4.2 | Good upfront sweetness, |
| | | | slightly watery, less bitter, |
| | | | slight sweet linger |
| Reb-A (170 ppm) + | 500 ppm | 2.5 | Nice profile, slight bitter |
| Reb-B (90 ppm) + | | | aftertaste |
| Reb-D (30 ppm) + | | | |
| Reb-M (210 ppm) | | | |
| Reb-A (155 ppm) + | 500 ppm | 3.1 | Some sweetness lingering, |
| Reb-B (90 ppm) + | | | balanced flavor |
| Reb-D (45 ppm) + | | | |
| Reb-M (210 ppm) | | | |
| Reb-A (175 ppm, 34%) + | 560 ppm | 4.4 | Good sweetness, clean profile, |
| Reb-B (95 ppm, 18%) + | | | much less sweetness lingering |
| Reb-D (45 ppm, 6%) + | | | than Reb M alone, good balance |
| Reb-M (200 ppm, 42%) | | | |
| Reb-A (170 ppm, 31%) + | 550 ppm | 4.1 | Good sweetness, clean profile, |
| Reb-B (90 ppm, 18%) + | | | slight sweetness lingering, |
| Reb-D (45 ppm, 9%) + | | | good balance, much less sweetness |
| Reb-M (220 ppm, 42%) | | | lingering than Reb M alone |
| Reb-B (100 ppm) + | 500 ppm | 1.7 | Good sweetness, clean profile, |
| Reb-D (30 ppm) + | | | slight sweetness lingering, |
| Reb-M (180 ppm) + | | | good balance |
| Reb-N (190 ppm) | | | |
| Reb-B (100 ppm) + | 500 ppm | 2.4 | Swell balanced, good lemon |
| Reb-M (190 ppm) + | | | flavor, not much lingering, |
| Reb-N (210 ppm) | | | slight bitter aftertaste |

Blends were preferred over Reb-M only by panelists in diet lemon lime carbonated beverage.

2.3. Sensory Evaluation for Diet Cola Carbonated Beverage

The following table shows the steviol glycosides in blends at different levels (ppm), the panelist ratings (1=most preferred, 5=least preferred) as well as the panelist comments.

| | Concentration | | |
|---|---|---|---|
| | (ppm) in | Average Panelist Rating | |
| Steviol Glycosides | Finished | (1 = most preferred, | |
| Blends | Beverage | 5 = least preferred) | Panelists Comments |
| Reb-M | 500 ppm | 2.6 | Good flavor, sweet linger, |
| | | | slightly bitter |
| Reb-M | 512 ppm | 2.8 | Good flavor, sweet linger, |
| | | | slightly bitter |
| Reb-A (170 ppm) + | 500 ppm | 2.4 | More round sweetness, |
| Reb-B (90 ppm) + | | | slightly bitter |
| Reb-D (30 ppm) + | | | |
| Reb-M (210 ppm) | | | |
| Reb-A (175 ppm, 34%) + | 560 ppm | 3.1 | Clean taste, fast sweet onset, |
| Reb-B (95 ppm, 18%) + | | | More round sweetness, |
| Reb-D (45 ppm, 6%) + | | | less sweet linger |
| Reb-M (200 ppm, 42%) | | | |
| Reb-A (170 ppm, 31%) + | 550 ppm | 2.9 | Clean taste, fast sweet onset, |
| Reb-B (90 ppm, 18%) + | | | More round sweetness, |
| Reb-D (45 ppm, 9%) + | | | less sweet linger |
| Reb-M (220 ppm, 42%) | | | |
| Reb-B (100 ppm) + | 500 ppm | 2.4 | Clean taste, fast sweet onset |
| Reb-M (190 ppm) + | | | |
| Reb-N (210 ppm) | | | |
| Reb-B (100 ppm) + | 500 ppm | 3.3 | Slightly bitter, more |
| Reb-D (30 ppm) + | | | sweetness lingering, |
| Reb-M (180 ppm) + | | | bitter aftertaste |
| Reb-N (190 ppm) | | | |
| Reb-D (45 ppm) + | 500 ppm | 4.2 | Herb-like notes, slight |
| Reb-N (190 ppm) + | | | bitter aftertaste |
| Reb-M (220 ppm) + | | | |
| Reb-O (45 ppm) | | | |

### Example 5

### Bench Top Solubility and Taste Evaluation

The following blends were evaluated in citric acid/caramel based beverages:

| Reb | Reb | Reb D | | | | Solubility | |
|---|---|---|---|---|---|---|---|
| A | B | (A95) | RebM80 | NSF-03 | Total | in | Taste |
| ppm | ppm | ppm | ppm | ppm | ppm | Syrup† | test |
| | 95 | 45 | 220 | 25 | 385 | Yes | |
| | | | 512 | | 512 | No | Yes |
| 175 | 95 | 45 | 220 | 25 | 560 | Yes | Yes |
| 170 | 90 | 45 | 220 | 25 | 550 | Yes | Yes |

†Throw 4.4 + 1; ≥45° F. (syrup operation temperature at bottlers)

While 512 ppm RebM80 was not soluble in syrup, blends containing reb A/reb B/reb D/rebM80 and NSF-03 were both soluble in syrup and tasted similar to the RebM80-only beverage.

### Example 6

### Impact of Siamenoside I and Mogroside V on Reb A/Reb M foaming

1. A high intensity sweetener or a blend of two high intensity sweeteners was dissolved in DI water to make a syrup with the concentration of up to 500 ppm. Each syrup was stored refrigerated at 4.5° C.
2. 45 mL of each syrup was added to a 10 oz glass bottle, and 225 mL of carbonated water (CO₂ volume: 4.6) was added to make a beverage sample (3.8 CO₂ volume and 5:1 throw ratio)
3. Each beverage sample was refrigerated at 4.5° C. for at least an hour
4. Each beverage bottle was twisted open and is inverted to pour the beverage into a 1000 mL glass beaker using a rotating clamp. The bottle was rotated until its opening hits the top of the beaker at 45° angle. This whole process was videotaped for foam height and foam diminishing time measurements.
5. Foam height is measured in mL when the meniscus of the foam on the beaker wall starts to move down uniformly
6. Foam diminishing time is measured in seconds between the time when a beverage hits the bottom of the beaker first and the time when the meniscus of the foam hits 350 mL line

(1) Rebaudioside A+Mogroside V, (2) Rebaudioside M+Mogroside V, (3) Rebaudioside A+Siamenosiode I, and (4) Rebaudioside M+Siamenosiode I are respectively prepared at 100, 300 and 500 ppm of total concentration in the final beverages.

Mogroside V blends with RebA or RebM

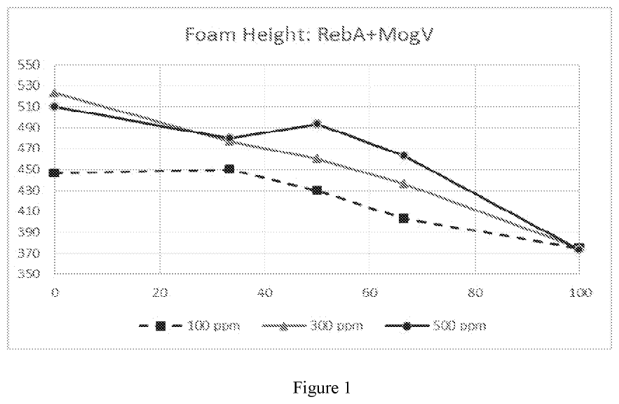

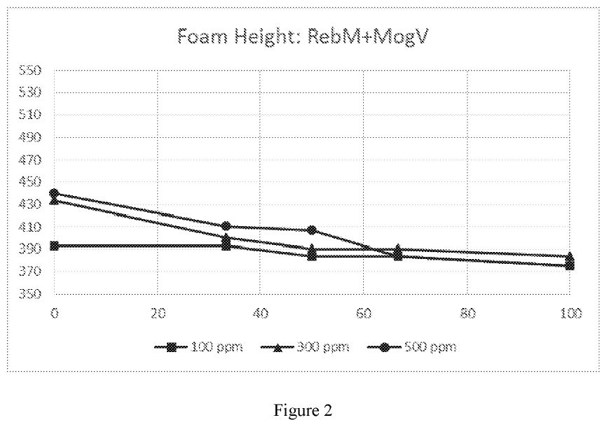

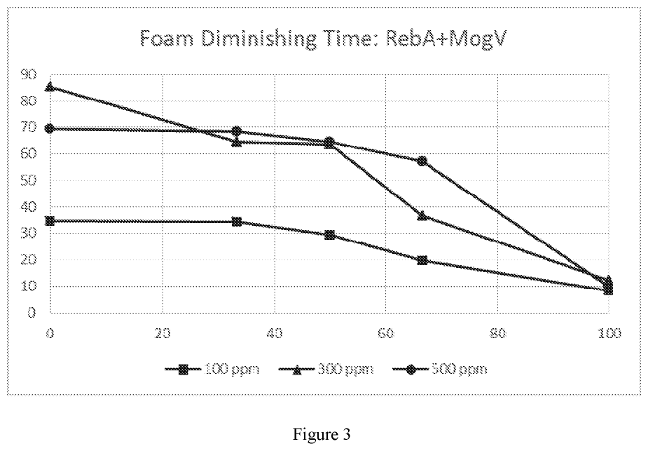

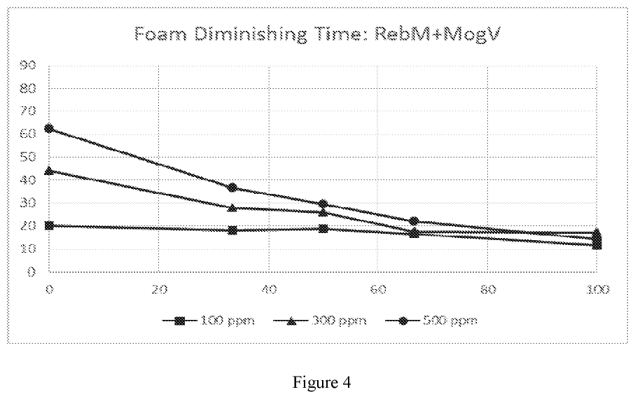

When Mogroside V was blended with RebA or RebM, both foam height and foam diminishing time were reduced with increasing percentage of Mogroside V at all three total concentrations (100, 300 and 500 ppm). However, the reduction profiles of these two different blends, namely RebA+MogV vs. RebM+MogV, differ significantly as shown in the FIGS. 1-4; RebA+MogV blends show more abrupt changes when the percentage of MogV exceeded 40% whereas RebM+MogV blends decreased gradually throughout in foam height and foam diminishing time.

Siamenoside I Blends with RebA or RebM

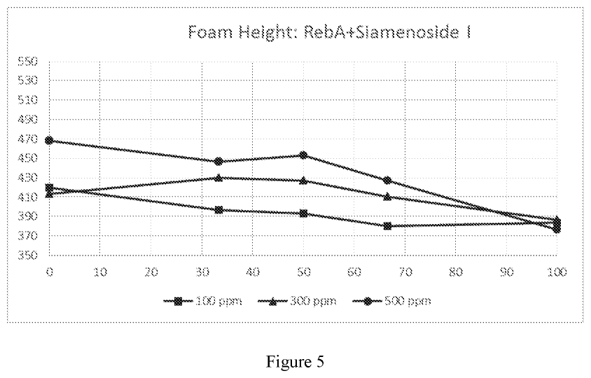

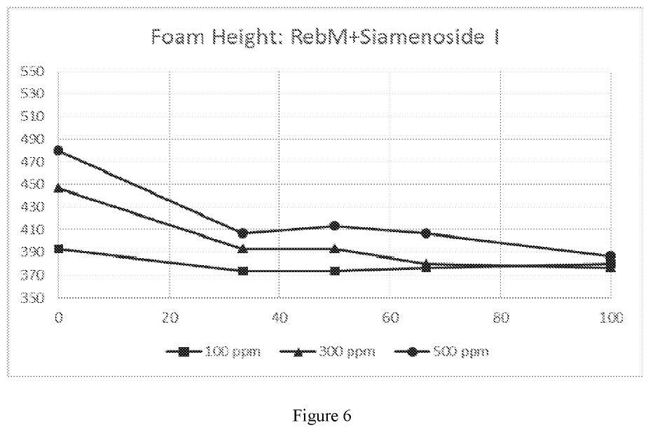

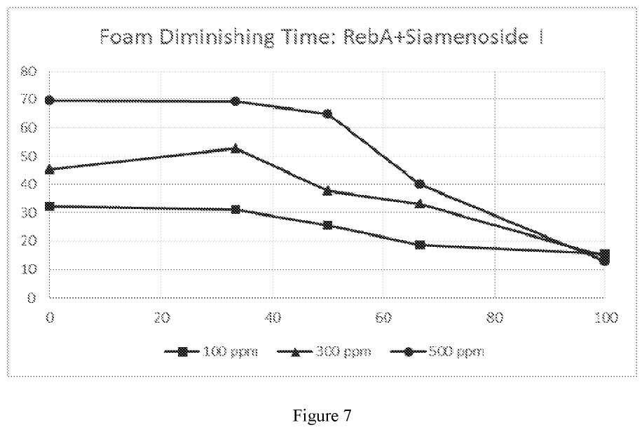

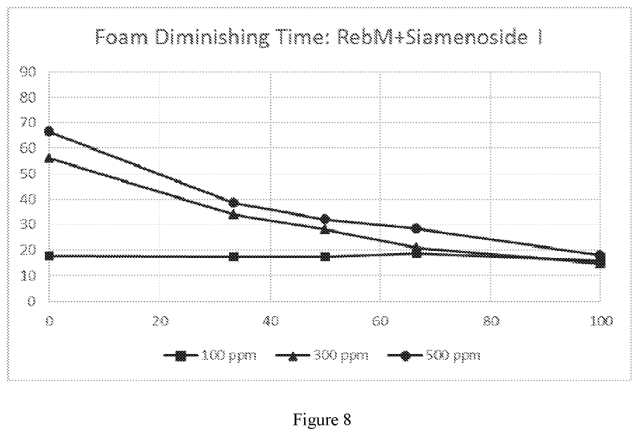

When Siamenoside I was blended with RebA or RebM, both foam height and foam diminishing time were reduced with increasing percentage of Siamenoside I at all three total concentrations (100, 300 and 500 ppm). However, the reduction profiles of these two different blends, namely RebA+Siamenoside I vs. RebM+Siamenoside I, differ significantly as shown in the FIGS. 5-8; RebA+Siamenoside I blends show more abrupt changes when the percentage of Siamenoside I exceeded 50% whereas RebM+Siamenoside I blends decrease gradually after 30% in foam height and foam diminishing time.

1. A Stevia blend comprising (i) from about 20 wt % to less than about 70 wt % of a steviol glycoside mixture comprising reb M and (ii) from about 25 wt % to about 80 wt % reb N, wherein the blend exhibits superior aqueous solubility at 0.25 wt %-0.4 wt % compared to a blend of only the steviol glycoside mixture comprising reb M.

2. The Stevia blend of claim 1, wherein said Stevia blend has an aqueous solubility at 0.25 wt %-0.4 wt % that is at least about 1.5× the aqueous solubility of the blend of only the steviol glycoside mixture comprising reb M and/or said Stevia blend has an aqueous solubility at 0.25 wt %-0.4 wt % that is at least about 1.5× the aqueous solubility of the blend without reb N.

3. The Stevia blend of claim 1, further comprising one or more steviol glycosides selected from the group consisting of reb A, reb B, reb C, reb G, reb N, reb D, reb E, reb O, reb J, isorebM, reb I and combinations thereof.

4. A concentrate containing water and from about 0.25 wt % to about 0.4 wt % of a Stevia blend of any of claims 1-3, wherein the concentrate is clear by visual inspection.

5. The concentrate comprising of claim 4, wherein the steviol glycoside blend comprises from about 20 wt % to about 60 wt % of a steviol glycoside mixture comprising reb M and from about 80 wt % to about 40 wt % reb N.

6. The concentrate of claim 4, wherein the steviol glycoside blend comprises from about 40 wt % to about 50 wt % of a steviol glycoside mixture comprising reb M, from about 10 wt % to about 20 wt % reb A and from about 40 wt % to about 50 wt % reb N.

7. The concentrate of claim 4, wherein the steviol glycoside blend comprises from about 40 wt % to about 50 wt % of a steviol glycoside mixture comprising reb M, from about 45 wt % to about 55 wt % reb N and from about 1 wt % to about 15 wt % reb D, wherein the concentrate has a steviol glycoside concentration from about 0.25 wt % to about 0.4 wt % and is clear by visual inspection.

8. The concentrate of claim 4, wherein the steviol glycoside blend comprises from about 45 wt % to about 55 wt % of a steviol glycoside mixture comprising reb M, from about 30 wt % to about 40 wt % reb A and from about 5 wt % to about 20 wt % reb B.

9. The concentrate of claim 4, wherein the steviol glycoside blend comprises from about 35 wt % to about 45 wt % of a steviol glycoside mixture comprising reb M, from about 35 wt % to about 45 wt % reb N and from about 5 wt % to about 25 wt % reb B.

10. The concentrate of claim 4, wherein the steviol glycoside blend comprises from about 30 wt % to about 50 wt % of a steviol glycoside mixture comprising reb M, from about 30 wt % to about 40 wt % reb N, from about 5 wt % to about 15 wt % reb D and from about 10 wt % to about 20 wt % reb 0.

11. The concentrate of claim 4, wherein the steviol glycoside blend comprises from about 35 wt % to about 45 wt % of a steviol glycoside mixture comprising reb M, from about 35 wt % to about 45 wt % reb N, from about 5 wt % to about 15 wt % reb D and from about 5 wt % to about 20 wt % reb E.

12. The concentrate of claim 4, wherein the steviol glycoside blend comprises from about 30 wt % to about 40 wt % of a steviol glycoside mixture comprising reb M, from about 1 wt % to about 10 wt % reb D, from about 35 wt % to about 45 wt % reb N and from about 5 wt % to about 25 wt % reb B.

13. The concentrate of claim 4, wherein the steviol glycoside blend comprises from about 30 wt % to about 40 wt % of a steviol glycoside mixture comprising reb M, from about 1 wt % to about 10 wt % reb D, from about 35 wt % to about 45 wt % reb N and from about 1 wt % to about 10 wt % reb 0.

14. A method of preparing a concentrate suitable for beverage formulation comprising:
a. providing super concentrate comprising water and from about 1 wt % to about 10 wt % of a Stevia blend of any of claims 1-3;
b. diluting the super concentrate to about 0.25 wt % to about 0.4 wt % with water and;
c. mixing at room temperature for at least 10 minutes to provide a concentrate, wherein the concentrate is clear by visual inspection.

15. A method of preparing a beverage comprising:
a. providing a concentrate of any of claims 4-13;
b. optionally adding one or more beverage ingredients;
c. mixing the concentrate with water to provide a beverage, wherein the volumetric ratio of concentrate to water is from about 1:3 to about 1:8.

16. The method of claim 16, wherein the volumetric ratio of concentrate to water is about 1:4.4 to about 1:6.

17. The method of claim 16, wherein the beverage selected from a zero-calorie or mid-calorie carbonated beverage.

18. The method of claim 19, wherein the beverage is selected from the group consisting of enhanced sparkling beverages, cola, fruit-flavored sparkling beverages, ginger-ale, soft drinks and root beer.

19. A method for improving the solubility of a Stevia blend comprising a steviol glycoside blend comprising reb M by substituting from about 20 wt % to about 80 wt % of the steviol glycoside blend comprising reb M with reb N.

20. A method of reducing foaming of a beverage comprising a Stevia blend comprising a steviol glycoside blend comprising reb M or reb A, said method comprising substituting from about 20 wt % to about 80 wt % of the steviol glycoside blend with a compound selected from reb N, siamenoside I, mogroside V and a combination thereof, to provide a blend with reduced foaming.
